(19) United States
(12) Patent Application Publication
(10) Pub. No.: US 2025/0357882 A1
(43) Pub. Date: Nov. 20, 2025

(54) CONNECTOR FOR ATTACHING A SOLAR PANEL TO A SUPPORT

(71) Applicant: Watershed Geosynthetics LLC, Alpharetta, GA (US)

(72) Inventor: Carl M. Davis, III, Canton, GA (US)

(73) Assignee: Watershed Geosynthetics LLC, Alpharetta, GA (US)

(21) Appl. No.: 18/870,905

(22) PCT Filed: Jun. 14, 2023
(86) PCT No.: PCT/US2023/025330

§ 371 Date: Dec. 2, 2024

Related U.S. Application Data
(60) Provisional application No. 63/353,126, filed on Jun. 17, 2022.

(51) Int. Cl. H02S 20/23; F16C 11/04; F24S 25/636

(52) U.S. Cl. CPC H02S 20/23; F16C 11/04; F24S 25/636

(57) ABSTRACT

A connector for securing a solar photovoltaic panel to a support, comprising a first plate for coupling with the support for holding a solar photovoltaic panel for generation of electrical energy and a second plate hingedly connected to the first plate for supporting a portion of the solar photovoltaic panel, and a clip for securing to the second plate and for holdingly contacting the solar panel, whereby the clip being secured to the second plate, holds the solar panel thereon. An array of a plurality of solar photovoltaic panels may be interconnected with the connectors for positioning on a surface for generation of electrical energy.

### TECHNICAL FIELD

The present invention relates to connectors for attaching solar photovoltaic modules to supports for generating electrical energy. More particularly, the present invention relates to connectors for attaching a solar photovoltaic module at an angle to a support for generating electrical energy yet selectively releasing one side from attachment for hingedly moving the solar panel for maintenance access from time-to-time, and for interconnecting solar photovoltaic modules in an array on a surface for generating electrical energy.

### BACKGROUND OF THE INVENTION

Solar photovoltaic modules provide for generation of electrical energy as an environmentally appropriate renewable energy source. Solar photovoltaic modules are elongated panels of various sizes, for example, 65 inches by 39 inches, typically holding 60 solar cells in a 6×10 grid, or 78 inches by 39 inches holding 72 cells in a 6×12 grid. The solar cells connect together and electrical energy generated by the cells communicates from the module to a power inverter for supply of electrical current to an electrical distribution grid. Modules can be used individually, or several can be connected to form arrays covering a surface area.

Arrays of solar photovoltaic modules often mount the modules to supports for holding the modules at an angle to the sun in rows, and multiple rows are spaced apart to reduce shading from modules in adjacent rows. The supports may be embedded into the ground, or have portions held by ballast to restrict wind uplift movement. The spacing allows persons and equipment to move through the array but reduces the energy generation capacity per unit area for the array. Arrays with closely-spaced solar photovoltaic modules further have access drawbacks.

There is a need in the art for an improved connector for attaching a solar photovoltaic module at an angle to a support for generating electrical energy yet selectively releasing from attachment for moving the solar panel for maintenance access as necessary from time-to-time and for interconnecting solar photovoltaic modules in an array on a surface for generating electrical energy. It is to such that the present invention is directed.

### SUMMARY OF THE INVENTION

The present invention meets the need in the art for an improved connector for attaching a solar photovoltaic module at an angle to a support for generating electrical energy yet selectively releasing one side from attachment for moving the solar panel for maintenance access as necessary from time-to-time. More particularly, the present invention provides a connector for securing a solar panel to a support structure, comprising a first plate for coupling with a support structure for positioning a solar panel for generation of an electrical current and a second plate for supporting a portion the solar pane. A hinge configured for connecting the second plate with the first plate, wherein the second plate being rotatable about the hinge to a selected angle relative to the first plate. A clip for securing to the second plate, said clip having a stem for abutting a portion of a side of the solar panel and a cap plate for extending laterally from the stem for overlying contact with a portion of a top surface of the solar panel, whereby the clip being secured to the second plate, holds the solar panel thereon.

In another aspect, the present invention provides a connector for securing a solar panel to a support structure, comprising a first plate for coupling with a support structure for positioning a solar panel for generation of an electrical current, a second plate for supporting a portion the solar panel with a pair of spaced-apart fingers projecting from the second plate in a first direction, for abutting a side of the solar panel; and a hinge for connecting the second plate to the first plate, wherein the second plate being rotatable about the hinge to a selected angle relative to the first plate.

In yet another aspect, the present invention provides an array of connected solar panels for generation of electrical energy, comprising a first and a second solar panel, each having a first side edge and an opposing second side edge and a pair of spaced-apart elongated rails for supporting said first and second solar panels. A first pair of fixed connectors each secured in spaced-apart relation to said first side edge of said first solar panel and to a respective rail. A pair of spacer connectors each secured in spaced-apart relation to said second side edge of said first solar panel and to said first side edge of said second solar panel, whereby said first solar panel and said second solar panel are coupled in spaced-apart relation. A second pair of fixed connectors each secured in spaced-apart relation to said second side edge of said second solar panel and to said respective rail.

Objects, advantages, and features of the present invention will become readily apparent upon a reading of the following detailed description in conjunction with the drawings.

### BRIEF DESCRIPTION OF THE DRAWINGS

FIG. 1 illustrates in perspective view a first hinge connector for attaching a solar photovoltaic module to a support in accordance with the present invention.

FIG. 2 illustrates the first hinge connector in side elevational view.

FIG. 3 illustrates the first hinge connector shown in FIG. 1 attached to a support and to a solar photovoltaic module.

FIG. 4 illustrates an array of a plurality of solar photovoltaic modules connected together with first hinge connectors and to a pair of spaced-apart supports for generating electrical energy yet selectively releasing a side of one of the solar photovoltaic modules from attachment to the supports for hingedly moving the solar panel for maintenance access as may be necessary from time-to-time.

FIG. 5 illustrates in detailed side elevational view a pair of solar photovoltaic modules connected together with a first hinge connector.

FIG. 6 illustrates in detailed perspective view a pair of solar photovoltaic modules in the array connected together with the first hinge connector.

FIG. 7 illustrates in perspective view a second hinge connector for attaching a pair of solar photovoltaic modules to the support in spaced-apart relation as an array of solar photovoltaic modules for generating electrical energy.

FIG. 8 illustrates an array of a plurality of solar photovoltaic modules connected together spaced-apart relation with hinge connectors and secured to a support for generating electrical energy.

FIG. 9 illustrates in detailed side elevational view a pair of solar photovoltaic modules connected together with a second hinge connector and to a support for holding the solar photovoltaic modules in the array illustrated in FIG. 8 for generating electrical energy.

FIG. 10 illustrates in detailed side elevational view a pair of solar photovoltaic modules connected together with the first hinge connector in the array illustrated in FIG. 8 for generating electrical energy.

### DETAILED DESCRIPTION

With reference to the drawings in which like parts have like identifiers, the present invention provides hinged connectors for attaching a solar photovoltaic module, or securing two or more solar photovoltaic modules in spaced-apart relation as an interconnected array, to a support for generating electrical energy such as in a solar energy farm installed on a large area land site or on a building structure. The support is configured for holding one or more panels above a surface such as ground. The hinged connectors have opposing flat plates that extend from a hinge connection. The plates provide a ledge on which a portion of a solar photovoltaic module (sometime referenced herein as a “panel”) rests on. The plates each have at least one mounting point for securing to the support. The mounting point also connects to a bracket or clamp for securing the panel in place on the plate. The plates each include a pair of opposing spaced-apart fingers that extend perpendicularly. The fingers abut a side of the panel to orient and hold the panel square to the hinge. A method of interconnecting adjacent solar photovoltaic modules together and securing to a support is disclosed.

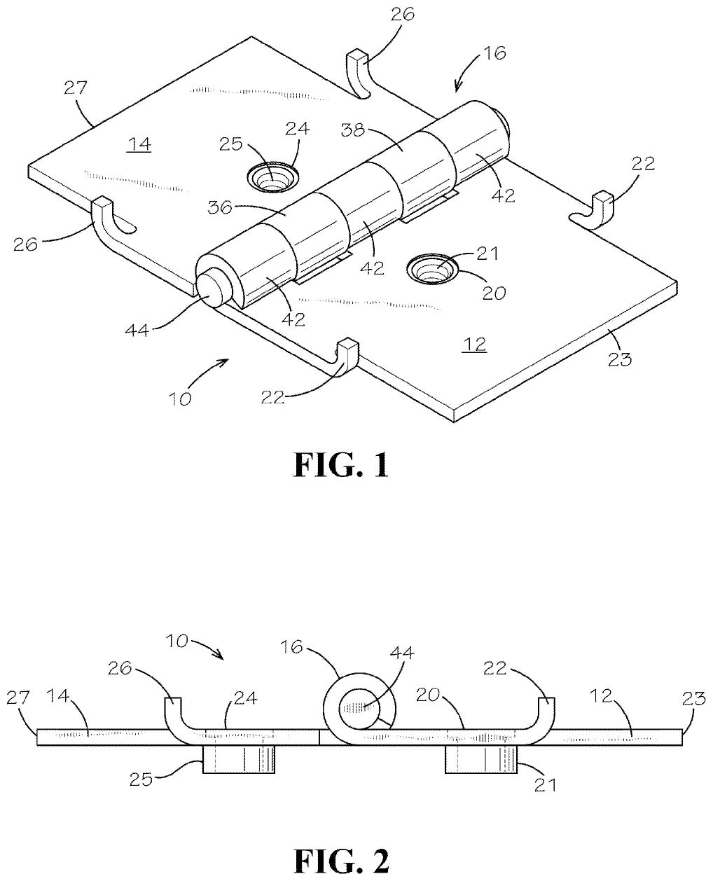

FIG. 1 illustrates in perspective view a first connector 10 and FIG. 2 illustrates the first connector 10 in side elevational view. As discussed below, the first connector 10 attaches a solar photovoltaic module to a support for generating electrical energy, yet periodically the connector may be selectively released from the support for hingedly pivoting the solar photovoltaic module for maintenance access as may be necessary from time-to-time. The first connector 10 comprises a first plate 12 and a second plate 14 connected by a hinge 16. The first plate 12 defines an opening 20 for receiving a fastener for coupling securely to a support for holding a solar photovoltaic module. In the illustrated embodiment, a threaded nut 21 attaches to an underside of the plate 12 in alignment with the opening 20 for receiving the threaded member such as a bolt or screw. A pair of opposing fingers 22 extend perpendicularly in a first direction from the first plate 12. The pair of fingers 22 are spaced from the hinge 16 intermediate the hinge and a distal edge 23 of the plate 12. The second plate 14 defines an opening 24 for receiving a fastener for a connector that secures a solar photovoltaic module on the second plate. In the illustrated embodiment, a threaded nut 25 attaches to an underside of the plate 14 in alignment with the opening 24 for receiving a threaded member such as a bolt or screw. A pair of opposing fingers 26 extend perpendicularly in a first direction from the second plate 14. The pair of fingers 26 are spaced from the hinge 16 intermediate the hinge and a distal edge 27 of the plate 14.

Each of the threaded nuts 21, 25 couples with the threaded fastener or bolt as discussed below, and may be attached to the respective plate 12, 14, such as self-clinching, broaching, flaring, surface mount, weld, or adhesive fastener device, to provide strong, reusable, and permanent threads and mounting points in metal plates, such as PEM nuts, or alternatively may be a separate threadable nut. A plate 12, 14 of sufficient thickness may define a respective threaded opening 20, 24.

The hinge 16 connects the first plate 12 to the second plate 14. The first plate 12 connects to a support 46. The hinge 16 enables the second plate 14 to be positioned at a selected angle to hold the solar photovoltaic module in an angled position for generating electrical energy. The hinge 16 comprises in the illustrated embodiment a pair of coaxially aligned circular tubes 36, 38 formed on an edge of the second plate 14 and at least one circular tube 42 on an edge of the first plate 12. The tube 42 of the first plate 12 coaxially aligns with the spaced-apart tubes 36, 38 of the second plate 14. The first plate 12 in the illustrated embodiment has three spaced-apart tubes 42, for matingly coaxially aligning with the two tubes 36, 38 of the second plate 14. A pin 44 inserts through the aligned tubes 36, 42, 38 for holding the coupled plates 12, 14 hingedly connected, whereby the plates 12, 14 are rotatable about the hinge 16, for example, the second plate 14 is rotatable about the hinge 16 to a selected angle relative to the first plate 12. The pin 44 may be removable. Although not illustrated, a cotter pin or other mechanism may be installed through an opening in an end portion of the pin to restrict the pin from sliding out. Alternatively, the pin 44 is fixed from removal within the hinge 16 such as with a cap or nut. The hinge 16 thereby comprises a first mating portion attached to the first plate 12 and a second mating portion attached to the second plate 14, said first and second mating portions matingly connecting together for coupling the second plate to the first plate while allowing the plates to rotate relative to each other, for example, the second plate 14 rotates relative to the first plate 12 secureed to the support 46 for orienting the solar photovoltaic module 48 at an angle.

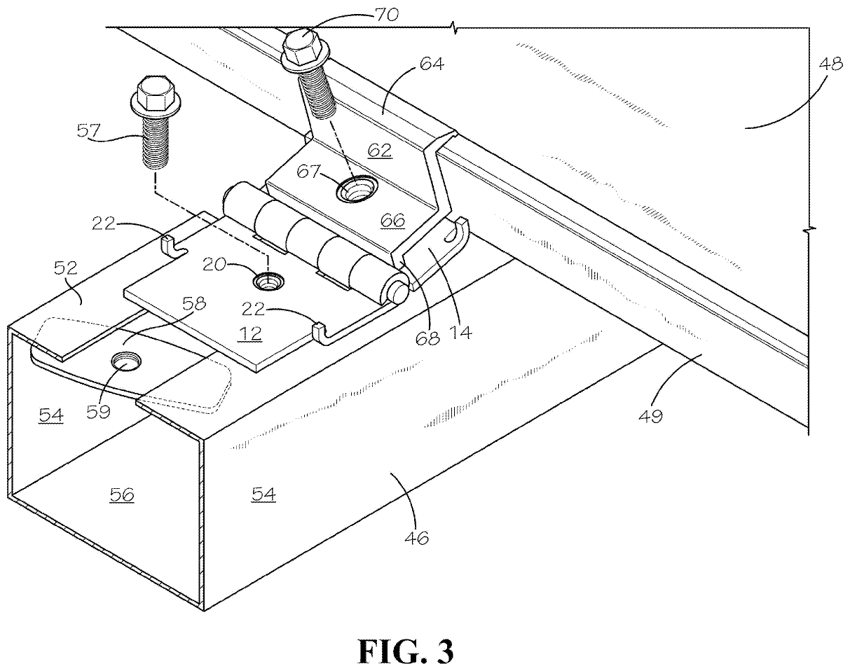

FIG. 3 illustrates the connector 10 attached to a support 46 and to a solar photovoltaic module 48. The support 46 comprises an elongate tubular member 50 having an upper surface 52, opposing side walls 54, and a bottom wall 56. The connector 10 sits on the upper surface 52. In the illustrated embodiment, a threaded fastener 57 and cross-member 58 secures the first plate 12 to the support 46. The threaded fastener 57 extends through the opening 20 and engages a threaded opening 59 in the cross-member 58. The distal ends of the cross-member 58 contactingly engage the inner surfaces of the opposing walls 54 on threadingly engaging the fastener 57 with the cross-member.

A side portion of the solar photovoltaic module 48 sits on the second plate 14. A side 49 abuts against the pair of extending fingers 26. A clip 60 secures the solar photovoltaic module 48 to the second plate 14. The clip 60 has a stem 62 from which a cap plate 64 extends laterally in a first direction. A foot 66 at an opposing end of the stem 62 extends laterally in an opposing direction. The foot 66 defines an opening 67 through which a fastener 70 extends to engage the nut 25 attached to the second plate 14. A stop 68 extends downwardly from the foot 66. The stem 62 abuts the side 49 of the solar photovoltaic module 48. The cap plate 64 extends laterally overlying a portion of the top surface of the solar photovoltaic module 48. The cap plate 64 bears on the top surface. The fastener 70 extends through the opening 67 and engages the threaded nut 25 of the second plate 14. As the fastener 70 tightens to the nut 25, the cap plate 64 engages the top surface of the solar photovoltaic module and secures the solar photovoltaic module to the second plate 22. The stop 68 bears against the upper surface of the second plate 14 and prevents the over-tightening of the fastener 70.

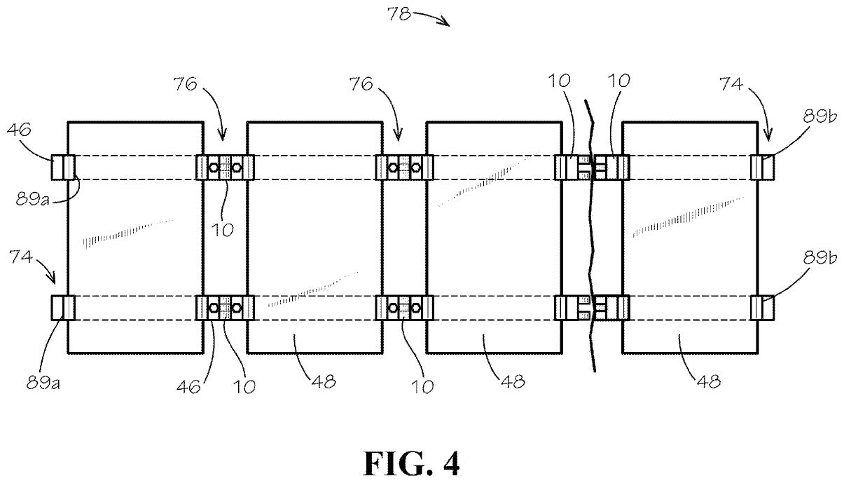

FIG. 4 illustrates a schematic diagram of an array 78 of a plurality of the solar photovoltaic modules 48 interconnected for positioning on a surface such as a land area or building roof The solar photovoltaic modules 48 connect together with respective pairs 76 of the first hinge connectors 10 and with pairs 74 of end connectors 89a, 89b for holding the respective solar photovoltaic modules together or to a pair of spaced-apart supports 46 for generating electrical energy yet a side of one of the solar photovoltaic modules selectively releasable from connection for hingedly moving the one solar panel for maintenance access as may be necessary from time-to-time. The schematic illustrated in FIG. 4 is not to scale, as the modules 48 are larger in size than the hinge connectors 10 and 89 but illustrates the interrelated connections of adjacent solar photovoltaic modules and the spaced-apart supports 46. The end connectors 89a, 89b are discussed below. The end connectors 89a secure a left side of an end solar photovoltaic modules in a spaced series of modules while end connectors 89b secure a right side of an end solar photovoltaic module in the series.

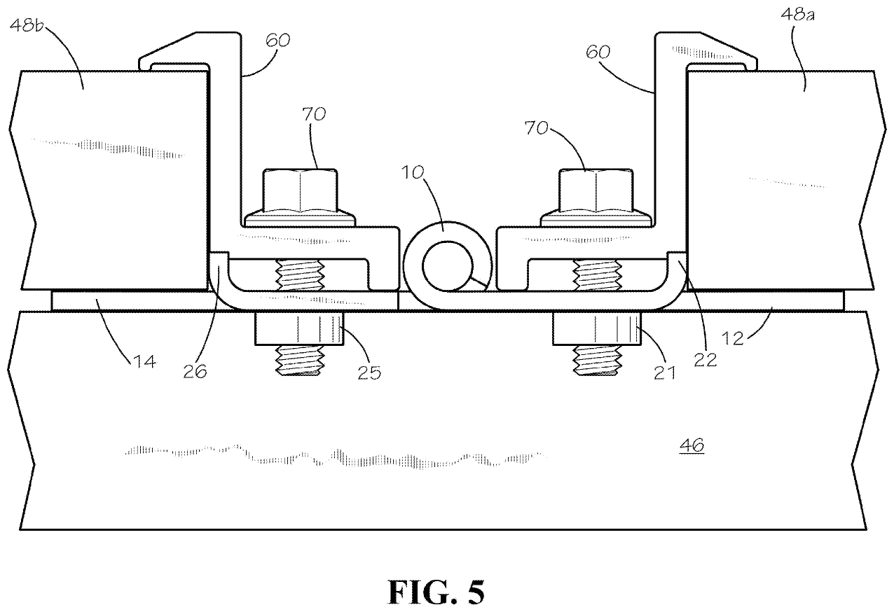

FIG. 5 illustrates in detailed side elevational view a pair of solar photovoltaic modules 48 connected together with the first hinge connector 10. A first solar photovoltaic module 48a seats on the plate 12 and the side 49 of the module 48a abuts the fingers 22 to hold the module square on the first hinge connector. The connector 60 secures the module 48a to the plate 12 with the fastener 70 threadably engaged with the nut 21. The stop 62 seats on an upper surface of the plate 12 to prevent overtightening of the fastener 70. Similarly, a second solar photovoltaic module 48b seats on the plate 14 and a side of the module 48b abuts the fingers 26 to hold the module solar photovoltaic square on the first hinge connector 14. The connector 60 secures the module 48b to the plate 14 with the fastener 70 threadably engaged with the nut 25. The upstanding fingers 22, 26 gainfully align the solar photovoltaic modules 48a, 48b, particularly when two supports 46 are used in spaced-apart relation for supporting the solar photovoltaic modules.

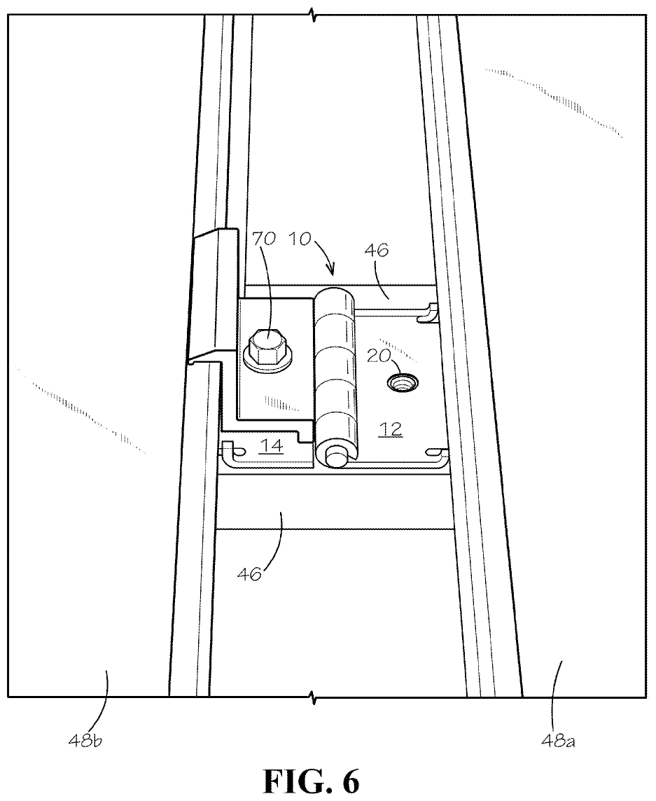

FIG. 6 illustrates in detailed perspective view the pair of solar photovoltaic modules 48a, 48b in the array 78 illustrated in FIG. 4 connected together with the first hinge connector 10 with one clip 60 shown installed for holding the solar photovoltaic module 48b to the support 46. A second one (not illustrated) of the clips 60 is installed for holding the solar photovoltaic module 48a to the support 46.

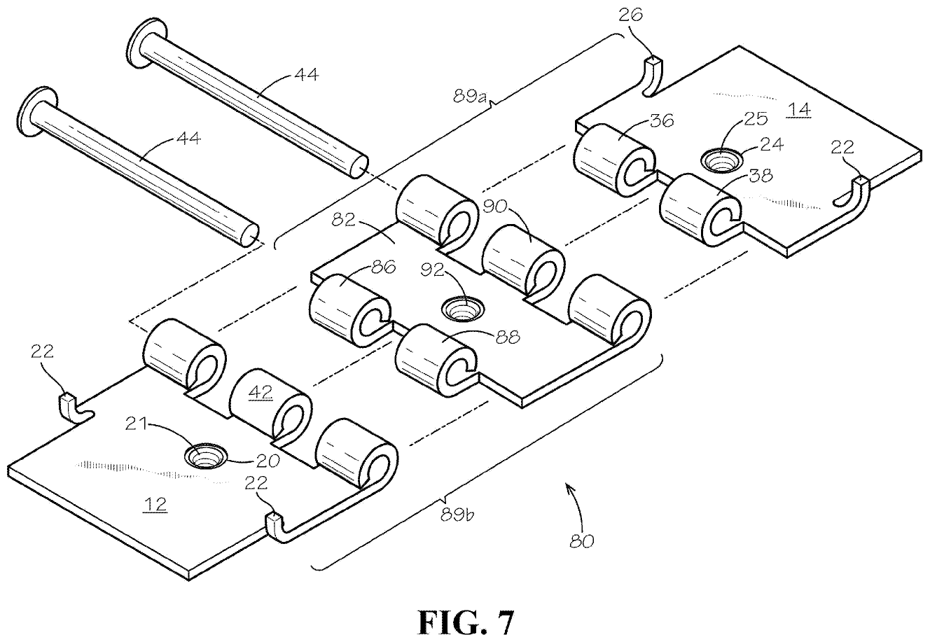

FIG. 7 illustrates in perspective view a second connector 80 for attaching a pair of solar photovoltaic modules 48 in spaced-apart relation to the support 46 for generating electrical energy in an array of solar photovoltaic modules. The second connector 80 disposes a spacer 82 in-between the first plate 12 and the second plate 14 to provide spacing of the pair of solar photovoltaic modules 48. The spacer 82 includes mating tubes 86, 88 and 90 on opposing sides for alignment and engagement with the respective tubes 42 of the second plate 14 and with the tubes 36, 38 of the first plate 12. The spacer 82 in the illustrated embodiment has a pair of tubes 86, 88 on one side and three tubes 90 on an opposing side. The pair of tubes 86, 88 align with the tube 42 of the second plate 14 while the tube 90 aligns with the pair of tubes 36, 38 of the first plate 12. Pins 44 insert through the respective aligned tubes for defining hinge connections between the spacer 82 and respectively the first plate 12 and the second plate 14. The spacer 82 defines an opening 92 for receiving one of the threaded fastener 57 and cross-member 58 to secure the spacer 82 and the hingedly connected plates 12, 14 to the upper surface of the support 46.

FIG. 7 further illustrates an end hinge connector 89a. The end hinge connector 89a uses the plate 14 hingedly coupled to the spacer 82 by a pin. Also, illustrated is an end hinge connector 89b that uses the plate 12 hingedly coupled to the spacer 82 by a pin. The end hinge connectors 89a, 89b may be used to secure respective left or right sides of a photovoltaic module 48 to the support 46, such as for example the end module in an array of modules. In applications of such embodiments, the spacer 82 attaches to the upper surface of the support 46 while the plate 14 or 12 attaches with the connector 60 and threaded fastener to clamp the photovoltaic module 48 to the end hinge connector 89a or 89b.

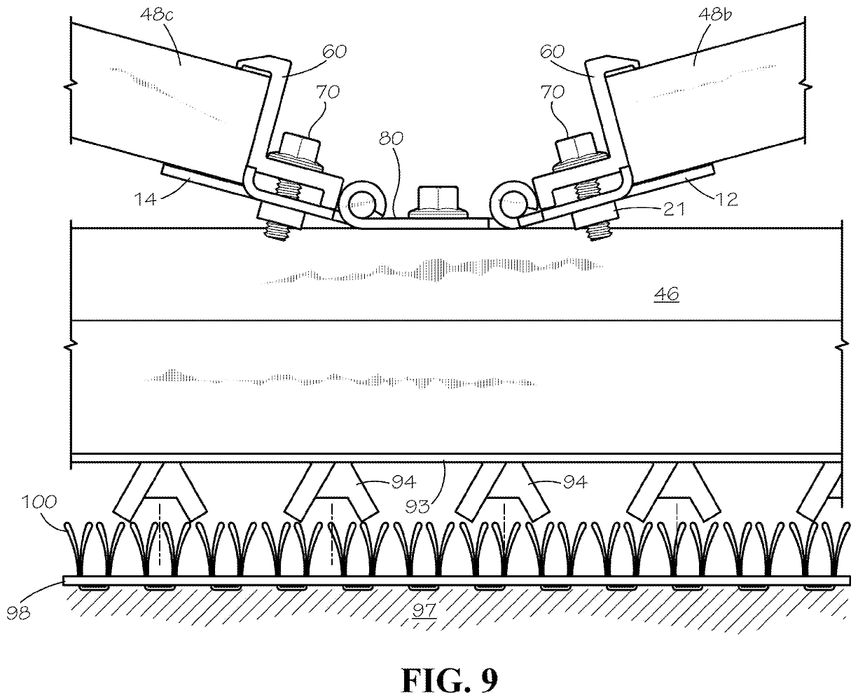

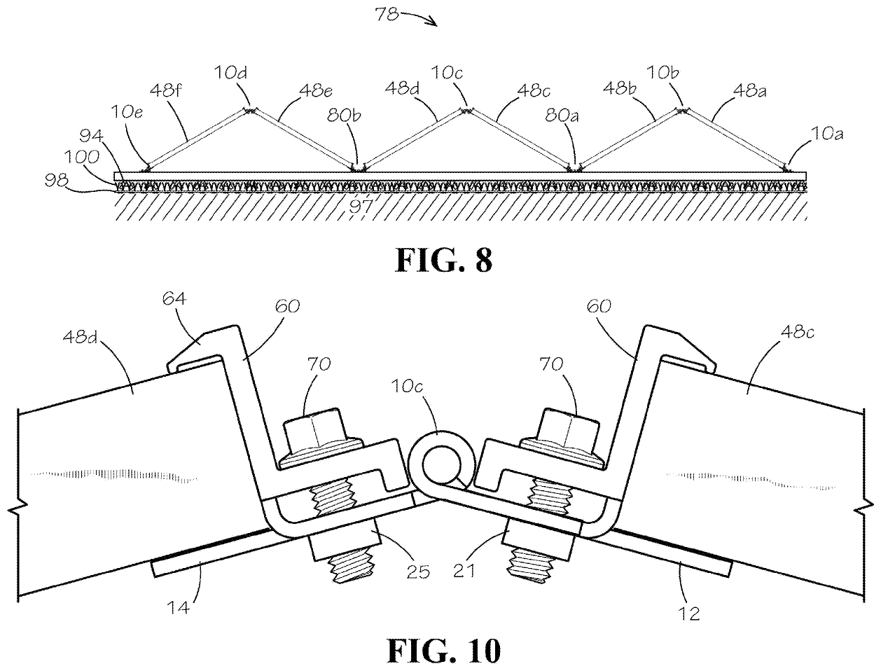

FIG. 8 illustrates a detailed side view of the array 78 of the plurality of solar photovoltaic modules 48 in connected series and respectively positioned in angled orientation using the hinge connector 80 to hold the modules in connected spaced relation and to the support 46. In the illustrated embodiment, the support 46 attaches to an elongated engagement strip 93 having a plurality of spaced-apart depending projections 94, legs, lugs, stubs, or pins, as extending members. The support 46 sits on a tufted geosynthetic turf 96 shown exploded therefrom on a land or other surface 97. The tufted geosynthetic turf 96 overlies the surface 97. The tufted geosynthetic turf 96 comprises a backing sheet 98 tufted with synthetic yarns to define a plurality of elongated simulated blades of grass blades 100. The projections 94 frictionally engage the blades 100 to hold the support 46 from movement.

As illustrated in FIG. 8, the array 78 assembles with the first hinged connector 10a attached to an end solar photovoltaic module 48a and to the support 46. (An alternate installation may use the hinged connector 89a or 89b, with the spacer 82 secured to the support 46 for an end connector.) An opposing side of the end solar photovoltaic module 48a connects to an adjacent intermediate solar photovoltaic module 48b with the first hinged connector 10b. An opposing side of the intermediate solar photovoltaic module 48b connects to an adjacent intermediate solar photovoltaic module 48c with one of the second hinged connectors 80a that also connects to the support 46. An opposing side of the intermediate solar photovoltaic module 48c connects to an adjacent intermediate solar photovoltaic module 48c with one of the second hinged connectors 80a that also connects with a fastener securing the spacer plate 82 to the support 46.

The assembly of the array 78 similarly assembles with other solar photovoltaic modules 48 and respective ones of the first and second hinged connectors 10, 80. An opposing side of the intermediate solar photovoltaic module 48c connects to an adjacent intermediate solar photovoltaic module 48d with the first hinged connector 10c. An opposing side of the intermediate solar photovoltaic module 48d connects to an adjacent intermediate solar photovoltaic module 48e with one of the second hinged connectors 80b that also connects to the support 46. An opposing side of the intermediate solar photovoltaic module 48e connects to an adjacent end solar photovoltaic module 48f with the first hinged connector 10d. An opposing side of the end solar photovoltaic module 48f connects to the support 46 with the first hinged connector 10e. (An alternate installation may use as the end connector the hinged connector 89a or 89b, with the spacer 82 secured to the support 46.)

FIG. 9 illustrates in detailed side elevational view interconnection of intermediate solar photovoltaic modules 48 with one of the second hinge connectors 80. In representative detailed view, the pair of intermediate solar photovoltaic modules 48b, 48c connect together with the second hinge connector 80a and to the support 46 for holding the solar photovoltaic modules in the array 90 illustrated in FIG. 8 for generating electrical energy.

FIG. 10 illustrates in detailed side elevational view interconnection of intermediate solar photovoltaic modules 48 with one of the first hinge connectors 10. In representative detailed view, the pair of solar photovoltaic modules 48c, 48d connect together with the first hinge connector 10c in the array 78 illustrated in FIG. 8 for generating electrical energy.

With reference to FIG. 4 and FIG. 8, a plurality of solar photovoltaic modules 48 secure together and to a support 46 with the hinge connectors 10 in spaced-apart relation as the array 78 of solar photovoltaic modules for generating electrical energy. The support 46 in the illustrated embodiment is an elongated tube that seats on a surface, such as ground or roof top, but may be a post, stem, or flanged plate member that secures to surface for supporting the connectors and solar photovoltaic modules on respective distal ends vertically spaced from the surface. The solar array 78 preferably positions a pair of the supports 46 in spaced-apart relation for supportingly connecting to and supporting respective opposing portions of the solar photovoltaic modules 48. Generally, the supports 46 are disposed with a first end at a lower portion of a sloped ground surface and an opposing end at a higher portion of the sloped ground. The installation disposes the solar photovoltaic modules 48 in a landscape profile orienting a longer width side of the solar photovoltaic module transverse to a longitudinal axis of the supports 46 but may alternatively selectively dispose the solar photovoltaic modules 48 with the width side of the module 48 parallel to a longitudinal axis of the supports 46.

With reference to FIG. 4, the array 78 assembles by disposing the pair of supports 46 in spaced-apart relation. A pair of the solar photovoltaic modules 48 are placed on the upper surface of the supports 46. The pair of the solar photovoltaic modules 48 connect together with a pair 76 of the connectors 10. The pair 76 are spaced-apart to connect to opposing end portions of the solar photovoltaic modules 48 in alignment with the respective one of the supports 46. A first module 48a connects to the first plates 12 and a second module 48b connects to the second plates 14. The modules 48a, 48b connect to the respective plates with the clips 60. The fingers 22 abut the side edge of the module 48a to align the module to the connector 10. The fingers 26 abut the side edge of the module 48b to align the module to the connector 10. The respective cap plate 64 extends laterally over an upper surface of the respective module 48. The clips 60 secure with the threaded fasteners to the respective nuts 21, 25 aligned with the openings 20, 24 in the respective plates 12, 14. This hingedly connects the two solar photovoltaic modules 48a, 48b together.

The module 48a then secures to the supports 46 with an end pair 74 of the connectors 10. A side portion of the solar photovoltaic module 48a seats on the respective second plates 14 of the respective connectors 10 in the end pair 74 for securing the right side of the module to the support 46. The fingers 26 abut the side of the module 48a to align the connector 10 to the module and the support 46. Clips 60 install with the respective cap plates 64 extending laterally over a portion of the upper surface of the module 48a and fasteners secure the clip to the second plate 14. The first plate 12 is then secured fixedly to the support 46 with the fastener and cross-plate 58. Tightening the fastener drives the distal ends of the cross plate into engaging contact with the interior walls and with the underside of the top wall of the support. In an alternate embodiment, the clip 60 secures with a self-tapping screw driven into the top wall of the support 46. This secures the solar photovoltaic module 48a fixedly to the supports 46. Alternatively, the end pair 74 are two of the end connectors 89b for right side end connection, and the spacers 82 are fixedly secured to the support 46 rather than the first plates 12.

A pair of end connectors 10 install on the left opposing side of the module 48b in alignment with the respective supports 46. The module 48b sits on the second plate 14 of the pair 74 of connectors 10. The fingers 26 abut the side of the module to align the module with the connectors. Clips 60 install with the respective cap plates 64 extending laterally over a portion of the upper surface of the module 48b and fasteners secure the clip to the second plate 14. Alternatively, the end pair 74 are two of the left end connectors 89a, and the spacers 82 are fixedly secured to the support 46 rather than the second plates 12.

With reference to FIGS. 8 and 10, the array 90 may be assembled with the adjacent solar photovoltaic modules 48 positioned at angled orientation relative to the ground. The pair of hingedly connected solar photovoltaic modules 48a, 48b are first connected together as described above and the first photovoltaic module 48a is secured to the support 46. With one side of the solar photovoltaic module 48a fixed in place, the pair of solar photovoltaic modules 48a, 48b are then lifted or raised to angled positions. This is accomplished by lifting the pair 76 of hinge connectors vertically from the supports 46. The module 48a pivots on the hinge of the secured end pair 74 of connectors 10 and on the hinge of the pair 76 of connectors 10 that join the opposing modules 48a, 48b. The solar photovoltaic module 48b also pivots on the hinges of the pair 76 on the left side and the opposing edge of the module 48b moves along the upper surface of the supports 46. When the modules 48a, 48b are at an appropriate angle, the end pair 74 of connectors are secured to the upper surface of the supports 46. The first plates 12 (or alternatively, the spacer 82) of the end pair 74 are secured fixedly to the support 46 with the fastener and cross-plate 58. Tightening the fastener drives the distal ends of the cross plate into engaging contact with the interior walls and with the underside of the top wall of the support. In an alternate embodiment, the clip 60 secures with a self-tapping screw driven into the top wall of the support 46. This secures the solar photovoltaic module 48b fixedly to the supports 46.

The opposing solar photovoltaic modules 48a, 48b hinged together are secured at an oblique angle relative to the supports 46. Fasteners secure the plates of the end pairs 74 of connectors 10 to the supports. The adjacent opposing sides of the connected modules 48a, 48b have respective lateral force vectors pushing oppositely and respective perpendicular force vectors downwardly towards the supports 46.

This procedure continues for the other solar photovoltaic modules 48 in the array 90.

In an application as the array 78 of a plurality of the solar photovoltaic modules 48, the leading and trailing solar photovoltaic modules may use the respective left and right end connectors 89a or 89b for securing the respective side of the leading and trailing end modules in the series. The fastener fixedly secures the spacer 82 to the support to hold the leading and trailing modules 48 in position.

A respective solar photovoltaic module 48 may readily be disconnected from one of the pairs of hinge connectors 10, for access underneath the array, such as to access cable trays or conduits or other maintenance that may be necessary from time to time.

The foregoing has described and illustrated embodiments of hinge connectors 10 and 80 for joining adjacent solar photovoltaic modules 48 together in a series as the array 74 connected by elongated supports 46, as well as left- and right-side end hinge connectors 89a, 89b for securing respective sides of end solar photovoltaic modules in the array, which connectors selectively detached for pivoting movement of a selected solar photovoltaic module for maintenance and service access. Modifications and changes the connectors disclosed herein may be made by persons of ordinary skill upon a reading of the forgoing without departure from the claims hereof setting forth the subject matter of the present invention.

1. A connector for securing a solar panel to a support structure, comprising:
a first plate for coupling with a support structure for positioning a solar panel for generation of an electrical current;
a second plate for supporting a portion the solar panel;
a hinge configured for connecting the second plate with the first plate, wherein the second plate being rotatable about the hinge to a selected angle relative to the first plate; and
a clip configured for securing to the second plate, said clip comprising:
a stem for abutting a portion of a side of the solar panel,
cap plate for extending laterally from the stem for overlying contact with a portion of a top surface of the solar panel, whereby the clip being secured to the second plate, holds the solar panel thereon,
a foot extending laterally from the stem and defining a passageway therethrough, and
a fastener for extending through the passageway for engaging the second plate to secure the clip thereto; and
a pair of spaced-apart fingers projecting from the second plate in a first direction, for abutting a side of the solar panel.

2. (canceled)

3. The connector as recited in claim 1, wherein the stem extends in a first direction and the foot extends in a second direction different from the first direction.

4. The connector as recited in claim 3, wherein the second direction is opposite the first direction.

5. The connector as recited in claim 1, wherein the clip further comprises a stop tab extending from a bottom surface of the foot for bearing on the second plate.

6. The connector as recited in claim 1, wherein the second plate further comprises a threaded member attached thereto for receiving the fastener to secure the clip to the second plate.

7. The connector as recited in claim 1, wherein the second plate further comprises a threaded passageway for engaging the fastener to secure the clip to the second plate.

8. The connector as recited in claim 1, wherein the hinge comprises a first mating portion attached to the first plate and a second mating portion attached to the second plate, said first and second mating portions matingly connecting together for coupling the second plate to the first plate while allowing the second plate to rotate relative to the first plate.

9. The connector as recited in claim 8, wherein:
said first mating portion comprises at least two spaced apart cylinders; and
said second mating portion comprises at least one cylinder received in coaxial alignment between the spaced-apart cylinders of the first mating portion; and
a pin received within the coaxially aligned cylinders of the first and second mating portions.

10. The connector as recited in claim 8, further comprising a spacer plate having a first mating portion and a second mating portion on opposing sides, said first mating portion for engaging the second mating portion of the second plate for hingedly moving said second plate relative to the spacer plate and said hinge comprising said second mating portion for engaging said first mating portion of the first plate, whereby the first and second plates are spaced apart by the spacer plate.

11. The connector as recited in claim 10, wherein:
said first mating portion comprises at least two spaced apart cylinders; and
said second mating portion comprises at least one cylinder received in coaxial alignment between the spaced-apart cylinders of the first mating portion; and
a pin received within the coaxially aligned cylinders of the first and second mating portions.

12. The connector as recited in claim 10, wherein the spacer plate further comprises a passageway for receiving a fastener for securing the spacer plate fixed to the support structure.

13. (canceled)

14. The connector as recited in claim 1, wherein the first plate further comprises:
a passageway defined therein for receiving a fastener; and
a pair of spaced-apart fingers projecting therefrom in a first direction, for abutting a side of a second solar panel disposed for a portion thereof being supported by the first plate; and
further comprising a second clip for securing the second solar panel to the first plate with a fastener for connecting the second clip to the first plate by extending through the passageway.

15. The connector as recited in claim 1, wherein the first plate defines an opening; and further comprising a fastener for extending through the opening in the first plate for coupling to the support structure.

16. The connector as recited in claim 1, further comprising an elongated rail as part of the support structure, said elongated rail having a surface that receives the first plate for being coupled thereto.

17. (canceled)

18. A connector for securing a solar panel to a support structure, comprising:
a first plate for coupling with a support structure for positioning a solar panel for generation of an electrical current;
a second plate for supporting a portion the solar panel with a pair of spaced-apart fingers projecting from the second plate in a first direction, for abutting a side of the solar panel; and
a hinge for connecting the second plate to the first plate, wherein the second plate being rotatable about the hinge to a selected angle relative to the first plate.

19. The connector as recited in claim 18, further comprising a clip configured for securing to the second plate, said clip having a stem for abutting a portion of a side of the solar panel, a cap plate extending laterally from the stem for overlying contact with a portion of a top surface of the solar panel, whereby the clip being secured to the second plate, holds the solar panel thereon, a foot extending laterally from the stem and defining a passageway therethrough, and a fastener for extending through the passageway for engaging the second plate to secure the clip thereto.

20. (canceled)

21. An array of connected solar panels for generation of electrical energy, comprising:
a first and a second solar panel, each having a first side edge and an opposing second side edge;
a pair of spaced-apart elongated rails for supporting said first and second solar panels;
a first pair of fixed connectors each secured in spaced-apart relation to said first side edge of said first solar panel and to a respective rail;
a pair of spacer connectors each secured in spaced-apart relation to said second side edge of said first solar panel and to said first side edge of said second solar panel, whereby said first solar panel and said second solar panel are coupled in spaced-apart relation; and
a second pair of fixed connectors each secured in space-apart relation to said second side edge of said second solar panel and to said respective rail.

22. The array of connected solar panels as recited in claim 21, wherein each said fixed connector comprises:
a first plate for coupling with the respective rail for positioning said respect solar panel for generation of an electrical current;
a second plate coupled with the first plate and for supporting a portion of said respective solar panel;
a hinge configured for coupling the second plate with the first plate, wherein the second plate rotatable about the hinge to a selected angle relative to the first plate; and
a clip configured for securing to the second plate and having a stem for abutting a portion of a side of the respective solar panel, a cap plate extending laterally from the stem for overlying contact with a portion of a top surface of said respective solar panel, whereby the clip being secured to the second plate, holds said solar panel thereon, a foot extending laterally from the stem and defining a passageway therethrough, and a fastener for extending through the passageway for engaging the second plate to secure the clip thereto.

23. The array of connected solar panels as recited in claim 21, wherein each said spacer connector each comprises a spacer plate having a first mating portion and a second mating portion on opposing sides, said first mating portion for hingedly engaging the second plate for moving said second plate relative to the spacer plate and said hinge comprising said second mating portion for engaging said first plate for moving said first plate relative to the spacer plate, whereby the first and second solar panels are spaced apart by the spacer plate.

24. The array of connected solar panels as recited in claim 23, wherein:
each said first mating portion comprises at least two spaced apart cylinders;
said second mating portion comprises at least one cylinder for being received in coaxial alignment between the spaced-apart cylinders of a respective first mating portion; and
a pin received within the coaxially aligned cylinders of the first and second mating portions.

25. The array of connected solar panels as recited in claim 24, wherein the spacer plate further comprises a passageway for receiving a fastener for securing the spacer plate fixed to the support structure.

26. The array of connected solar panels as recited in claim 25,
wherein the first plate further comprises a passageway defined therein for receiving a fastener; and
further comprising a second clip for securing said respective solar panel to the first plate with the fastener connecting the second clip to the first plate by extending through the passageway.

27. The array of connected solar panels as recited in claim 23, wherein the first plates and the second plates each further comprise a pair of spaced-apart fingers projecting therefrom in a first direction, for abutting a side of said respective solar panel.
